(19) United States
(12) Patent Application Publication
(10) Pub. No.: US 2019/0199672 A1
(43) Pub. Date: Jun. 27, 2019

(54) DIGITAL MESSAGING PRIORITIZATION WITHIN AN ORGANIZATION

(71) Applicant: Knowmail S.A.L LTD., Tikva (IL)

(72) Inventors: Oded Avital, Ganey Tiqua (IL); Avi Mandelberg, Hod Ha'Sharon (IL); Yury Gubman, Jerusalem (IL); Shmuel Ur, Shorashim (IL)

(21) Appl. No.: 15/850,688

(22) Filed: Dec. 21, 2017

(51) Int. Cl. H04L 12/58

(52) U.S. Cl. CPC H04L 51/26; H04L 51/20; H04L 51/22

(57) ABSTRACT

A method, apparatus and computer program product, the method comprising: receiving a communication message transmitted to a user associated with an organization; obtaining a user score for the communication message; applying one or more rules from a set of rules to the communication message to obtain an organization score for the communication message, wherein the rules reflect prioritization provided by the organization; and displaying to the user a set of communication messages in an order, wherein the communication messages comprise the communication message, and wherein the order is affected by the organization score of the communication message, thereby overriding an order determined in accordance with the user score.

### TECHNICAL FIELD

The present disclosure relates to communication message systems in general, and to enhancing prioritization of communication messages within an organization, in particular.

### BACKGROUND

Electronic-based communication message, such as e-mails, instant messages, Short Message Service (SMS) messages, Whatsapp™ messages, Facebook™ private messages, or the like, is a method of exchanging digital messages from an author to one or more recipients. E-mail is a prominent example of such communication system, which is referred to be herein as an example of a communication system.

Current communication systems are mostly client-server based. A server is an application that receives communication messages from clients, or from other servers. A server may serve a list of users, and comprises or uses a storage area, a set of user definable rules, and a series of communication modules. The storage area is where received communication messages are stored for local users, and where communication messages in transit to another destination are temporarily stored. It usually takes the form of a database of information. The user defined rules determine how the server should react when determining the destination of a specific message, or possibly react to the sender of the communication message. For example, specific addresses can be barred, or certain users can be restricted to only sending messages within the company. The list of users is a database of user accounts that the server recognizes and will deal with locally, and the communication modules are components that actually handle the transfer of messages to and from other servers and clients. Depending upon the requirements of the server, a number of different modules may be installed and used by the server.

A client is an application, used by users for reading, composing, sending and receiving communication messages. A client may be installed on a user's computing platform, but may additionally or alternatively be implemented as a web page accessed for example using a browser. The client usually comprises an editor, an address book, a folder collection or hierarchy in which messages may be stored, and communication modules. The address book allows users to store commonly used addresses in an easy to get at format, reducing the chance of addressing errors.

A communication system implemented within an organization usually consists of one or more servers, each connected to a multiplicity of clients, each client associated with a user or another entity within the organization, such as an employee, a group of employees, a resource such as a room, or the like. The communication system may handle incoming and outgoing communication messages, wherein the communication messages may be addressed to one addressee within the organization, to multiple addresses within the organization, or to all clients of the communication system.

In normal operation mode, a client composes a communication message addressed to one or more addressees. Zero, one or more of the addressees may be from the same organization, i.e., connected to the same server, and zero, one or more may be external to the organization. After composing the communication message, the message is sent and distributed by the server to the internal addressees, if any, or to one or more external servers for distribution to the external addressees, if any.

In normal operation mode, a client receives from the server communication messages from users within the organization or external to the organization. The user may view the received (or the sent) communication messages, and may order them in accordance with predetermined parameters, such as receipt date and time, sender, subject, or the like.

### BRIEF SUMMARY

One exemplary embodiment of the disclosed subject matter is a computer-implemented method comprising: receiving a communication message transmitted to a user associated with an organization; obtaining a user score for the communication message; applying one or more rules from a set of rules to the communication message to obtain an organization score for the communication message, wherein the rules reflect prioritization provided by the organization; and displaying to the user a set of communication messages in an order, wherein the communication messages comprise the communication message, and wherein the order is affected by the organization score of the communication message, thereby overriding an order determined in accordance with the user score. Within the method, the order is optionally affected by the user score. Within the method, the user score is optionally determined by applying user rules to the communication message. Within the method, the user score is optionally determined based on user behavior related to previous messages. The method can further comprise determining the user score based on user behavior related to previous messages. Within the method, the user score is optionally a default score. Within the method, the organization score is optionally based on a factor selected from the group consisting of: a sender; a receiver; a topic discussed in the communication message; a title; similarity to another communications message; one or more words comprised in the communication message; a time at which the communication message; a device the user is using at a time the set of rules is applied; and a location of the user at the time the set of rules is applied. Within the method, the receiver is optionally determined implicitly. The method can further comprise: determining an explanation to a location of the communication message within the order; and displaying the explanation to the user. Within the method, said determining and said displaying are optionally subject to receiving a user request. The method can further comprise: determining an assessed effect of the rules on exposure of at least the user to communication messages; and providing to the organization a report comprising the assessed effect. The method can further comprise: determining a predicted effect of the rules on exposure of at least the user to communication messages; and providing to the organization a report comprising the predicted effect. The method can further comprise: determining an effect of the rules on exposure of at least the user to previously transmitted communication messages to which the at least one rule has been applied; and providing to the organization a report comprising the effect.

Another exemplary embodiment of the disclosed subject matter is a computerized apparatus having a processor, the processor being adapted to perform the steps of: receiving a communication message transmitted to a user associated with an organization; obtaining a user score for the communication message; applying one or more rules from a set of rules to the communication message to obtain an organization 5 score for the communication message, wherein the rules reflect prioritization provided by the organization; and displaying to the user a set of communication messages in an order, wherein the communication messages comprise the communication message, and wherein the order is affected by the organization score of the communication message, thereby overriding an order determined in accordance with the user score. Within the apparatus, the order is optionally affected by the user score determined by applying user rules to the communication message or based on user behavior related to previous messages. Within the apparatus, the organization score is optionally based on a factor selected from the group consisting of: a sender; a receiver; a topic discussed in the communication message; a title; similarity to another communications message; one or more words comprised in the communication message; a time at which the communication message; a device the user is using at a time the set of rules is applied; and a location of the user at the time the set of rules is applied. Within the apparatus, the processor is optionally further adapted to: determine an explanation to a location of the communication message within the order; and display the explanation to the user. Within the apparatus, the processor is optionally further adapted to: determine an assessed effect or predicted effect of the rules on exposure of at least the user to communication messages; and provide to the organization a report comprising the assessed effect or predicted effect.

Yet another exemplary embodiment of the disclosed subject matter is a computerized apparatus having a processor, the processor being adapted to perform the steps of: receiving a communication message transmitted to a user associated with an organization; obtaining a user score for the communication message; applying one or more rules from a set of rules to the communication message to obtain an organization score for the communication message, wherein the at least one rule reflects prioritization provided by the organization; and displaying to the user a set of communication messages in an order, wherein the communication messages comprise the communication message, and wherein the order is affected by the organization score of the communication message, thereby overriding an order determined in accordance with the user score.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method for prioritizing communication messages in accordance with company rules, in accordance with some exemplary embodiments of the disclosed subject matter;

FIG. 2 shows a flowchart diagram of a method for receiving and assessing company rules, in accordance with some exemplary embodiments of the disclosed subject matter; and

FIG. 3 is a schematic block diagram of a computing platform executing a server and a computing platform executing a client, in accordance with some exemplary embodiments of the disclosed subject matter.

### DETAILED DESCRIPTION

In the description below, the terms “mail”, “e-mail”, “email”, “message”, “communication” or “communication message” are used interchangeably and refers to an electronic communication message that may be transmitted by an author or sender to one or more intended recipients and may be consequently received by devices of such recipients. The term should be construed to exclude broadcasted messages, such as posts in a bulletin board, posts in a social network, or the like, which are not designated to a specific user or group of users, and which can be viewed by users who the message was not originally intended to. The term is not limited to any specific protocol. Exemplary protocols for transmitting such messages may include Simple Mail Transfer Protocol (SMTP), Post Office Protocol (POP3), Internet Message Access Protocol (IMAP), Short Message Service (SMS) or the like.

In the description below, unless indicated otherwise, the term “user” relates to a receiver or addressee of a communication message.

The term “organization” can relate to a commercial company, a governmental organization, a non-governmental organization, a financial organization, a health care institute, an academic institute, or the like.

One technical problem dealt with by the disclosed subject matter is that of correctly prioritizing communication messages based on the needs of the organization. In some cases, organizations may want to ensure that users, such as but not limited to employees of the organization, are exposed to certain communication messages. In some cases, messages may be displayed based on their assigned priority, such that messages assigned with higher priority get higher exposure than other messages with lower priority. In some exemplary embodiments, communication messages may be displayed to a user in the order at which they are received from the server, or in another order indicated by the user, regardless of their importance or priority to the organization. In addition, in some cases, prediction models may be trained based on the user's behavior over time, to customize the prioritization based on the user's preference. However, the user's preference may contradict or not be aligned with the organization's needs. Hence, the company may wish to utilize a technical system which would allow it to make a particular communication message more prominent so as to increase the chances that the user sees the communication message and handles it as soon as possible.

One technical solution relates to a set of organization rules defined for an organization, for example by an administrator, policy maker, or another person. Each rule associates one or more requirements with a score indicating a priority of the message. The requirement may be described for example as one or more fields of the message such as sender, title, or the like, as detailed below, and corresponding values or value ranges thereof. For example, messages wherein the sender is the CEO may be assigned high score, messages whose subject mentions a key customer are assigned a high score, or the like. It will be appreciated that one or more rules may involve combinations, i.e., requirements on the values of multiple fields, wherein the requirements may or may not be interrelated.

Each message may also be associated with a user score wherein the user is the addressee, also referred to as a receiver. The user score may be set in accordance with one or more rules defined by the user, may be a default score, may be a score determined using a predictive model that is trained based on the user's past activity, or the like. For example, a user may set a rule that communication messages from family members are assigned highest score, messages related to a project his is working on are assigned a high score, or the like.

Once a set of organization rules is defined, communication messages addressed to users within the organization are tested against one or more of the organization rules. If one or more of the rules is applicable to the communication message then an organization score is set in accordance with the rule. As an example, if the communication message comprises a field having a value complaint with what is prescribed in the rule, the rule may be applicable to the communication message. It will be appreciated that the rule may require a combination of one or more fields and values, value ranges, or the like. Additionally or alternatively, more than one rule may be applied to the same communication message. Additionally or alternatively, the rule may define fuzzy parameters and may not require exact matches, such as providing leeway for typos and use of synonyms.

The communication message may then provided to the user, and may be displayed together with some or all of the user's messages. The messages may be displayed in an order which is affected by the organization score, and not in an order corresponding to the user score. The display order thus represents the organization priorities, which may be associated with the organization hierarchy, business, ideology, or other principles. In some embodiments, the order in which the messages are displayed is determined in accordance with the organization score alone, thus overriding the user score. In some embodiments, a combined score is used, for example an average or a weighted average of the organization score and the user score. In some embodiments, the user score can be used for determining an internal order within messages having the same organization score.

In some embodiments, once an organization rule is found to be applicable, no other organization rules are tested and the score is as determined in accordance with the organization rule. In other embodiments, all organization rules may be tested, and the score may be set to be the highest score associated with any of the applicable organization rules. In further embodiments, the score may be set to be a combination of the scores associated with the applicable organization rules.

In some embodiments, after the messages are displayed in an order affected by the organization score, the user may change the display such that messages are ordered in accordance with a secondary criterion such as date, sender, user score, or the like. In some embodiments, messages will remain sorted in accordance with the organization score, and will not let the user change the order. In some embodiments, messages having high organization score may remain at the top of the message list, also referred to as “pinned”, while other messages can be sorted in accordance with the user preferences.

One technical effect of the disclosure relates to providing communication messages to a user associated with an organization, such that the order in which the messages are displayed is affected by organization score associated with each message. Thus, an order formed by user scores is overridden in order to promote messages which are considered by the organization as having higher priority. The display can thus give precedence to messages which are prioritized by the organization, due for example to the sender, the subject, or other criteria representing the organization policy.

In some cases, user-tailored scoring is overridden for important messages, in accordance with the preferences of the organization, while disregarding the user's preference. As a result, the disadvantage of adapting the scores based on the user's actions is mitigated, and the organization can rest assure that certain messages will have high visibility in desired audiences.

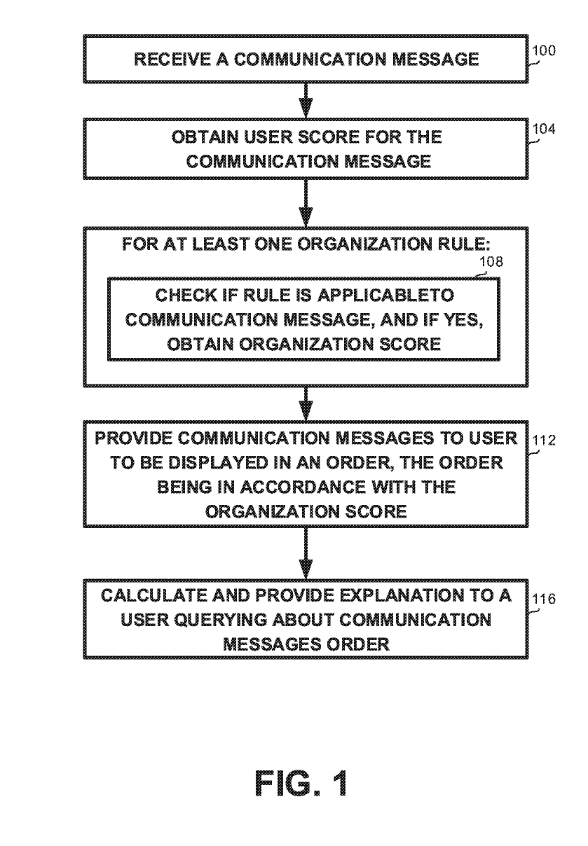

Referring now to FIG. 1, showing a flowchart diagram of a method for prioritizing communication messages in accordance with company rules, in accordance with some exemplary embodiments of the disclosed subject matter.

On step 100, a communication message may be received by an organization communication message server. The communication message may be sent from a sender internal or external to the organization, and may be addressed to one or more users within the organization and optionally to users external to the organization.

On step 104, a user score may be obtained for the communication message. The user score may be determined in accordance with factors such as sender, subject or words therein, date or time the message was sent, whether the user is addressed or copied, a communication channel used (e.g., SMS message or instant message), or the like. Additionally or alternatively, the user score may be determined based on behavior of the user regarding previously received messages. For example, if the user first reads communication messages from certain senders, then new communication messages from these senders can be assigned a higher score. Additionally or alternatively, the score may depend on a current user-context, such as the current activity of the user, based on external events such as newly published news items, a device user by the user (e.g., desktop computer or mobile device), user indicated status, such as leisure time, Do Not Disturb (DND) time, or the like. Additionally or alternatively, the user score may be a default score, for example the highest score may always be assigned to the most recently received message. In some embodiments, the user score may be determined at a later time, when the message is received by the client used by the user.

On step 108, for at least one organization rule, it may be checked whether the rule is applicable to the message, e.g. whether the message is in compliance with the requirement, for example any of the following:
Communication messages sent by a specific sender or group of senders. For example, communication messages sent by the CEO or VPs of the organization may receive higher score;
Communication messages addressed to one or more addressees. It will be appreciated that for certain addressees the message may have a first score while for others it many have a different score. For example, a message related to safety which is sent to all the organization members may be assigned higher score for the relevant managers of production teams and lower score for administrators. Moreover, the addressees having the relevant scores need not be defined explicitly, but may be defined based on roles in the organization, demographic parameters, geo-location, past activity, online profile, likes and dislikes, or the like. In some cases, the target audience for which a certain score applies may be defined upon a set of users, to automatically determine a target profile and target the set itself and other users similar thereto. For example, the target profile may take into account the users roles and projects, such that a target audience of people who work on specific projects but are not managers may be targeted. The relevant information may be obtained from organizational databases, social network platforms internal or external to the organization, or the like.
Communication messages having a specific title, wherein the title may be identical to a predetermined title; the title may have similarity exceeding a predetermined threshold to another title; or the title may comprise any one or more predetermined words. For example messages whose title indicate their relation to a strategic customer may receive higher score;
Communication messages discussing a specific topic, for example a communication message whose content is determined to be related to a severe problem may receive higher score;
Communication messages sent at particular time or date, or time or date range. For example, communication messages sent at late night hours may be urgent and therefore receive higher score;
Communication messages sent when the user is using a predetermined device. For example, if the addressee is using a mobile phone, a communication message discussing an electricity shortage in the office may receive higher score such that a janitor will notice the message and know that he is expected to rush back to the office to assist in resolution of the event, while if the user is already in the office the shortage is known to be handled anyway, and hence does not require higher scoring;
Communication messages sent when the user is known to be at a specific location, which may become known from the user's calendar. For example, if the user is known to be at a customer site, a communication message related to a problem with the customer may receive higher score;
Communication messages specifically indicated, such as broadcast message sent by the CEO, can be manually indicated as important. The CEO may indicate such importance before sending the communication message via her client. Additionally or alternatively, after the communication message is sent, the message may be manually selected by an administrator and indicated as an important message throughout the organization, or in certain audiences thereof; and
Any combination of one or more of the above factors or additional ones.

If the rule is applicable, an organization score may be obtained for the message. The organization score may be a numeric value, such as between 0 and 1, 1 and 10, between 1 and 100, one of a number of predetermined non-numeric but ordered values such as “high”, “medium”, “low”, or the like. Alternatively, the score may depend upon the communication message itself, for example be a function of one or more fields in the message, such as a function of the time elapsed since the communication message was sent.

In some embodiments, rules may be checked until one applicable rule is found, and the organization score is determined in accordance with that rule. In some embodiments, a multiplicity of organization rules, for example all organization rules may be checked, and the organization score may be set to the highest score of all applicable rules, or to a function of the scores, for example sum, average or the like.

On step 112, communication messages, including the communication message are provided to the client device used by the user, to be displayed in an order affected by the score. For example, the order may be strictly determined by the organization score. In other examples, the order can be determined upon a combination of the organization score and he user score. In some embodiments the user can change the order in which the messages are initially displayed. In some embodiments, the order is fixed and cannot be changed. In some embodiments, messages having the same organization score can be sorted according to the user's preferences, for example in accordance with the user score.

On step 116, a query may be received from a user related to the order of the messages, or to why a certain message is displayed prominently. Upon receiving the query, an explanation may be determined, indicating for example the user score, the organization score, a combined score, a user rule with which the message complies, an organization rule with which the message complies, or the like.

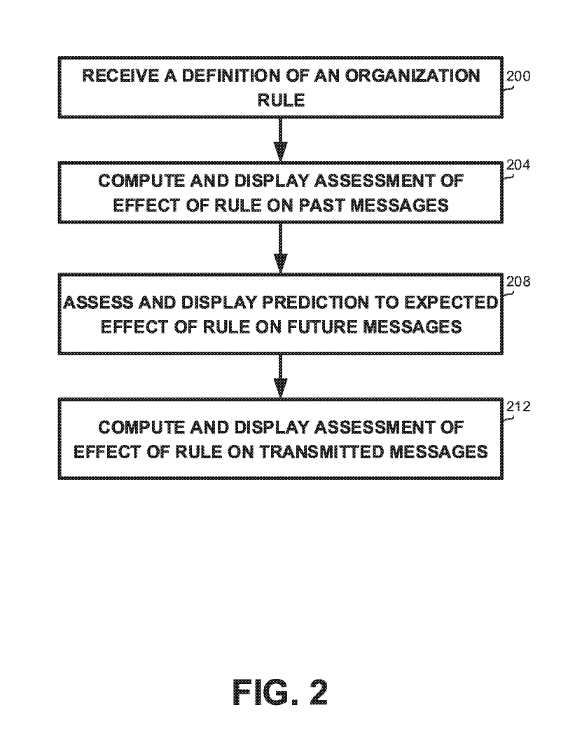

Referring now to FIG. 2, showing a flowchart diagram of a method for receiving and assessing company rules, in accordance with some exemplary embodiments of the disclosed subject matter.

On step 200, a definition of one or more organization rules may be received. The definition may be received from a user using a dedicated user interface, or as a file in text or another format, retrieved from a storage device, or the like. The rule may include criteria, such as sender, date, etc., and corresponding values as detailed above, and a numeric or another score or a function for calculating the score. The rule may further comprise an explicit or implicit definition of the target audience to which the rule may apply. For example, the rule may define a target audience to which it is applicable. The target audience may be defined based on positions, roles or responsibility areas within the organization, demographic parameters, geo-location, past activity, online profile, or the like. In some cases, the target audience may be defined based on a target profile to target the set itself and other users similar thereto. For example, the target profile may take into account the users' preferences, likes and dislikes, wherein the information may be based internal databases, external databases such as social networks, or the like.

On step 204, the effect of the current rules on past messages may be computed and optionally displayed to a user, wherein the user may be a system administrator, a policy maker, a person in charge of carrying out management decisions, or the like. The effect may include the number of messages per user, per user group, per the organization, or the like, which would have been ordered in a different manner have the current set of rules being applied in the past, for example starting at a certain date and time. A distribution of the messages affected by each rule may also be provided. In some embodiments, the messages that would have been prioritized and thus ordered differently by one or more rules, or at least the headers thereof, may be displayed. In some embodiments, a user interface may enable the user to turn on or off consideration of one or more of the rules, in order to view their effect on the messages.

On step 208, the effect of the current rules on future messages may be predicted and optionally displayed to a user, wherein the user may be a system administrator, a policy maker, a person in charge of carrying out management decisions, or the like. The prediction may include the number of messages per user, per user group, per the organization, or the like, which are estimated to be prioritized and thus ordered in a different manner depending on whether the current set of rules is applied or not, for example until a certain date and time. A distribution of the number of messages affected by each rule may also be provided. In some embodiments, a user interface may enable the user to turn on or off consideration of one or more rules, in order to view their effect on the prediction.

On step 212, after one or more rules have been in effect for a period of time, the effect of the rules on transmitted messages may be computed and optionally displayed to a user, wherein the user may be a system administrator, a policy maker, a person in charge of carrying out management decisions, or the like. The effect may include the number of messages per user, per user group, per the organization or the like which have been prioritized and thus ordered in a different manner due to the application of the rules, for example in a certain time frame. A distribution of the number of messages affected by each rule may also be provided, and in some embodiments, the affected messages or headers thereof may be displayed. In some embodiments, a user interface may enable the user to turn on or off consideration of one or more rules, in order to view their effect on the transmitted messages.

The options listed above, of getting a prediction or a feedback related to the effectivity pf rules may be used, for example, for any of the following purposes:
Determining whether a rule has an effect. For example, a rule giving high score to messages related to a specific project of a customer is ineffective if another rule already exists which gives high priority to all projects of the customer;
If a rule exists that gives a high score to messages of a particular subject, but historic data proves that people are interested in that subject anyway, then the rule is ineffective;
If a rule exists that gives a high score to messages of a particular subject, but historic data proves that no messages or almost no messages are received related to this subject then the rule is ineffective.

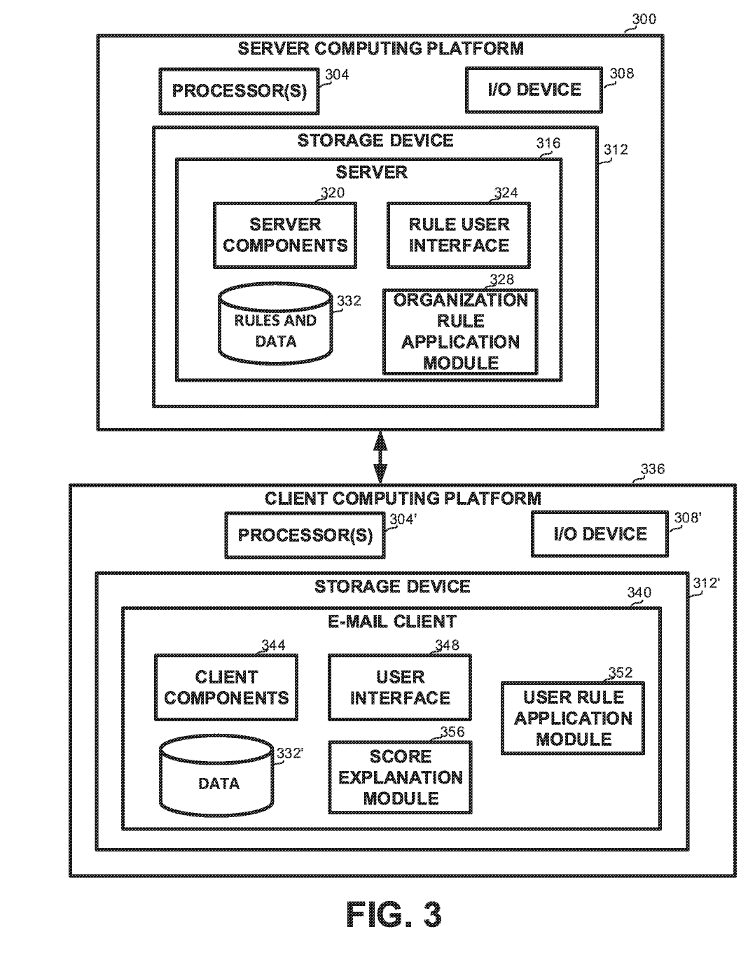

Referring now to FIG. 3, showing a schematic block diagram of an apparatus comprising a server computing platform 300 and a client computing platform 336 in accordance with some exemplary embodiments of the disclosed subject matter.

In some exemplary embodiments, server computing platform 300 may be such as a server, a desktop computer, a mobile computer, or the like.

Computing platform 300 may comprise one or more processor(s) 304. Processor 304 may be a Central Processing Unit (CPU), a microprocessor, an electronic circuit, an Integrated Circuit (IC) or the like. Processor 304 may be utilized to perform computations required by the apparatus 300 or any of it subcomponents.

In some exemplary embodiments of the disclosed subject matter, computing platform 300 may comprise an Input/Output (I/O) device 308 such as a display, a pointing device, a keyboard, a touch screen, or the like. I/O device 308 may be utilized to provide output to and receive input from a user.

In some exemplary embodiments, computing platform 300 may comprise a storage device 312. Storage device 312 may be a hard disk drive, a Flash disk, a Random Access Memory (RAM), a memory chip, or the like. In some exemplary embodiments, storage device 312 may retain program code operative to cause the processor 304 to perform acts associated with any of the subcomponents of computing platform 300. The components detailed below may be implemented as one or more sets of interrelated computer instructions, executed for example by processor 304 or by another processor. The components may be arranged as one or more executable files, dynamic libraries, static libraries, methods, functions, services, or the like, programmed in any programming language and under any computing environment.

Storage device 312 may store server 316, for managing the communication message services within an organization. Server 316 may comprise server components 320 which provide the regular functionality of a communications server, such as communication with users and with other servers, user and account management, security, backup, or the like. Server components 320 may further comprise additional components including rule user interface 324 and organization rule application module 328.

Rule user interface 324 may include user interface for a user such as an administrator to define rules. A rule may be defined by entering one or more criteria for the rule to be applicable to a message, and a score or a function that provides the score. Rule user interface 324 may also enable the user to view the assessed or predicted effect of one or more rules on message transmission.

Organization rule application module 328 may receive one or more messages, and may check whether any one or more of the rules is applicable to the message. If a rule is applicable, organization rule application module 328 may calculate the organization score for the message and associated it with the message, for example store in a predetermined field.

Storage device 312 may store rules and messages data 332, for example in one or more databases, each of which may be comprised in, or otherwise operatively connected storage device 312. Rules and messages data 332 may comprise the rules as defined, messages as received or transmitted within the system, and optionally additional data, such as effectivity analysis, predictions, or the like.

Client computing platform 336 is in communication with server computing platform 300. It will be appreciated that a multiplicity of client computing devices can communicate with one or more server computing platforms 300.

Client computing platform 336 may comprise processor 304′, I/O device 308′ and storage device 312′ analogous to processor 304, I/O device 308 and storage device 312′ of server computing platform 300.

Client computing platform 336 may comprise a client 340, which may comprise client components 344, user interface 348, user rule application module 352 and score explanation module 356.

Client components 344 are responsible for the normal operation of the communication client, such as an e-mail client, including for example operations such as communication with a server, folder management, backup, or the like.

User interface 348 can be configured to display communication messages in accordance with their score, which may be the organization score, or a combination of the organization score and user score as described above. In some embodiments, user interface 348 can enable a user to change the order in which the messages are displayed.

User rule application module 352 can apply one or more user rules to incoming messages, and obtain a user score which may or may not be combined with the organization score. The rule application can comprise checking if a rule is applicable to a message, and if it is then obtaining the user score.

Score explanation module 356 can receive an indication to a message, and generate an explanation to why the message was at the particular place in the communication list as displayed. The explanation can comprise a list of user or company rules applicable to the message, the resulting user score and company score, or the combination therebetween.

Client computing platform 336 can comprise or be operatively associated with message data 332′ stored on one or more databases. Message data 332′ can comprise communication messages of the user, and associated data such as a folder hierarchy, user scores, or the like.

It will be appreciated that server computing platform 300 and client computing platform 336 or parts thereof can be implemented on one or more machines. For example, server computing platform 300 and client computing platform 336 can be implemented on one machine accessed through the Internet. In alternative embodiment, server computing platform 300 and client computing platform 336, excluding user interface 348, can be implemented on one machine, and only user interface 348 may be implemented on a user's device. It will be appreciated that multiple other implementation combinations can be designed and used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
receiving a communication message transmitted to a user associated with an organization;
obtaining a user score for the communication message;
applying at least one rule from a set of rules to the communication message to obtain an organization score for the communication message, wherein the at least one rule reflects prioritization provided by the organization; and
displaying to the user a set of communication messages in an order, wherein the communication messages comprise the communication message, and wherein the order is affected by the organization score of the communication message, thereby overriding an order determined in accordance with the user score.

2. The method of claim 1, wherein the order is affected by the user score.

3. The method of claim 1, wherein the user score is determined by applying user rules to the communication message.

4. The method of claim 1, wherein the user score is determined based on user behavior related to previous messages.

5. The method of claim 1 further comprising determining the user score based on user behavior related to previous messages.

6. The method of claim 1, wherein the user score is a default score.

7. The method of claim 1, wherein the organization score is based on a factor selected from the group consisting of: a sender; a receiver; a topic discussed in the communication message; a title; similarity to another communications message; at least one word comprised in the communication message; a time at which the communication message; a device the user is using at a time the set of rules is applied; and a location of the user at the time the set of rules is applied.

8. The method of claim 7, wherein the receiver is determined implicitly.

9. The method of claim 1, further comprising:
determining an explanation to a location of the communication message within the order; and
displaying the explanation to the user.

10. The method of claim 9, wherein said determining and said displaying are subject to receiving a user request.

11. The method of claim 1, further comprising:
determining an assessed effect of the at least one rule on exposure of at least the user to communication messages; and
providing to the organization a report comprising the assessed effect.

12. The method of claim 1, further comprising:
determining a predicted effect of the at least one rule on exposure of at least the user to communication messages; and
providing to the organization a report comprising the predicted effect.

13. The method of claim 1, further comprising:
determining an effect of the at least one rule on exposure of at least the user to previously transmitted communication messages to which the at least one rule has been applied; and
providing to the organization a report comprising the effect.

14. A computerized apparatus having a processor, the processor being adapted to perform the steps of:
receiving a communication message transmitted to a user associated with an organization;
obtaining a user score for the communication message;
applying at least one rule from a set of rules to the communication message to obtain an organization score for the communication message, wherein the at least one rule reflects prioritization provided by the organization; and
displaying to the user a set of communication messages in an order, wherein the communication messages comprise the communication message, and wherein the order is affected by the organization score of the communication message, thereby overriding an order determined in accordance with the user score.

15. The apparatus of claim 14, wherein the order is affected by the user score determined by applying user rules to the at communication message or based on user behavior related to previous messages.

16. The apparatus of claim 14, wherein the organization score is based on a factor selected from the group consisting of: a sender; a receiver; a topic discussed in the communication message; a title; similarity to another communications message; at least one word comprised in the communication message; a time at which the communication message; a device the user is using at a time the set of rules is applied; and a location of the user at the time the set of rules is applied.

17. The apparatus of claim 14, wherein the processor is further adapted to:
determine an explanation to a location of the communication message within the order; and
display the explanation to the user.

18. The apparatus of claim 14, wherein the processor is further adapted to:
determine an assessed effect or predicted effect of the at least one rule on exposure of at least the user to communication messages; and
provide to the organization a report comprising the assessed effect or predicted effect.

19. A computer program product comprising a computer readable storage medium retaining program instructions, which program instructions when read by a processor, cause the processor to perform:
receiving a communication message transmitted to a user associated with an organization;
obtaining a user score for the communication message;
applying at least one rule from a set of rules to the communication message to obtain an organization score for the communication message, wherein the at least one rule reflects prioritization provided by the organization; and
displaying to the user a set of communication messages in an order, wherein the communication messages comprise the communication message, and wherein the order is affected by the organization score of the communication message, thereby overriding an order determined in accordance with the user score.
